(19) United States
(12) Patent Application Publication
(10) Pub. No.: US 2016/0028336 A1
(43) Pub. Date: Jan. 28, 2016

(54) CONTROL APPARATUS FOR ELECTRIC MOTOR AND CONTROL METHOD FOR ELECTRIC MOTOR

(71) Applicant: HITACHI AUTOMOTIVE SYSTEMS, LTD., Hitachinaka-shi, Ibaraki (JP)

(72) Inventors: Toshiaki OYAMA, Isesaki-shi, Gunma (JP); Tomonobu KOSEKI, Isesaki-shi, Gunma (JP)

(73) Assignee: HITACHI AUTOMOTIVE SYSTEMS, LTD., Hitachinaka-shi, Ibaraki (JP)

(21) Appl. No.: 14/418,550

(22) PCT Filed: Jul. 10, 2014
(86) PCT No.: PCT/JP2014/068481

§ 371 Date: Jan. 30, 2015

(30) Foreign Application Priority Data
Aug. 5, 2013 (JP) 2013-162812

(51) Int. Cl. H02P 6/12

(52) U.S. Cl. CPC H02P 6/12

(57) ABSTRACT

A control apparatus for an electric motor has a drive circuit that drives the electric motor in which a plurality of phase coils are star-connected, a neutral point drive circuit connected to a neutral point of the star connection, semiconductor relays that cut off an electric path connecting the neutral point and the neutral point drive circuit, and a microcomputer. Furthermore, the microcomputer cuts off the electric path by the semiconductor relays when it is possible to normally drive the electric motor by the drive circuit.

### TECHNICAL FIELD

The present invention relates to a control apparatus for an electric motor and to a control method for an electric motor.

### BACKGROUND ART

As has been disclosed in Japanese Patent Application Laid-open Publication No. 2007-99066 (Patent Document 1), a control apparatus for an electric motor in which a plurality of phase coils are star-connected drives the electric motor using drive systems free of the occurrence of abnormalities by a neutral point drive circuit connected to a neutral point of the star connection, when an abnormality has occurred in drive systems for driving the phase coils. Furthermore, in this control apparatus, when an abnormality has occurred in the neutral point drive circuit, contacts of a relay arranged in an electric path connecting the neutral point and the neutral point drive circuit are released (opened) to prevent problems from being caused in driving of the electric motor. The presence or absence of the abnormality in the neutral point drive circuit has been diagnosed by, for example, comparing a pulse width modulation (PWM) signal supplied to a switching element of the neutral point drive circuit and the voltage of the neutral point.

### REFERENCE DOCUMENT LIST

### Patent Document

Patent Document 1: Japanese Patent Application Laid-open Publication No. 2007-99066

### SUMMARY OF THE INVENTION

### Problems to be Solved by the Invention

In such a control apparatus for an electric motor, however, there might be a possibility that when an abnormality occurred in drive systems that drive phase coils, current due to the abnormality flowed in the neutral point drive circuit through the neutral point, and therefore, the neutral point drive circuit would be diagnosed erroneously as abnormal even though the neutral point drive circuit was normal. When the neutral point drive circuit is misdiagnosed as abnormal, the contacts of the relay arranged in the electric path connecting the neutral point and the neutral point drive circuit are opened. Accordingly, it is not possible to continuously drive the electric motor by the neutral point drive circuit.

Thus, the present invention aims to provide a control apparatus for an electric motor and a control method of the electric motor, which have improved abnormality diagnostic accuracy of a neutral point drive circuit.

### Means for Solving the Problems

A control apparatus for an electric motor has a drive circuit that drives the electric motor in which a plurality of phase coils are star-connected, a neutral point drive circuit connected to a neutral point of the star connection, semiconductor relays that cut off an electric path connecting the neutral point and the neutral point drive circuit, and a microcomputer. The microcomputer cuts off the electric path by the semiconductor relays when it is possible to normally drive the electric motor by the drive circuit.

### Effects of the Invention

According to the present invention, even though an abnormality occurs in the drive systems of phase coils in the electric motor, no current due to the abnormality flows in the neutral point drive circuit. It is therefore possible to improve abnormality diagnostic accuracy of the neutral point drive circuit.

### BRIEF DESCRIPTION OF THE DRAWINGS

FIG. 1 is a schematic diagram illustrating an example of an electric power steering apparatus.

FIG. 2 is an outline diagram illustrating a first embodiment of a control apparatus of an assisting motor.

FIG. 3 is an explanatory diagram of a first modification of a cutoff relay.

FIG. 4 is an explanatory diagram of a second modification of a cutoff relay.

FIG. 5 is an outline diagram illustrating a second embodiment of a control apparatus of an assisting motor.

FIG. 6 is an outline diagram illustrating a third embodiment of a control apparatus of an assisting motor.

FIG. 7 is an outline diagram illustrating a fourth embodiment of a control apparatus of an assisting motor.

FIG. 8 is an outline diagram illustrating a fifth embodiment of a control apparatus of an assisting motor.

FIG. 9 is an explanatory diagram of another method for detecting a ground fault of a neutral point drive line.

### MODE FOR CARRYING OUT THE INVENTION

Embodiments for carrying out the present invention will hereinafter be described in detail with reference to the accompanying drawings.

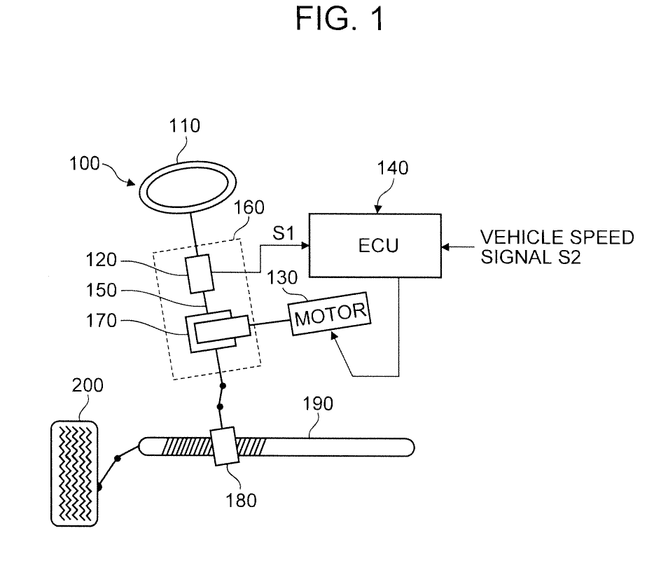

FIG. 1 illustrates one example of an electric power steering apparatus mounted on a vehicle.

An electric power steering apparatus 100 has a steering wheel 110, a steering torque sensor 120, an assisting motor 130, and a control apparatus 140 that controls assisting motor 130. Steering torque sensor 120 and a reduction gear 170 are incorporated in a steering column 160 that includes a steering shaft 150 coupled to steering wheel 110. Assisting motor 130 is given as one example of an electric motor that is an object to be controlled by control apparatus 140.

When a driver of the vehicle operates steering wheel 110, steering torque sensor 120 detects steering torque that acts on steering shaft 150 and outputs this steering torque signal S1 to control apparatus 140. Control apparatus 140 determines an assist force for assisting a steering force on the basis of steering torque signal S1 output from steering torque sensor 120 and a vehicle speed signal S2, etc. and drives assisting motor 130 with an operation amount corresponding to the assist force. When assisting motor 130 is driven, a pinion gear 180 attached to a tip portion of steering shaft 150 rotates so that a rack shaft 190 being meshed with pinion gear 180 is moved in a vehicle width direction. Therefore, the operation force of steering wheel 110 by the driver is transmitted to a steered wheel 200 while being assisted by assisting motor 130, so that the direction of the vehicle changes.

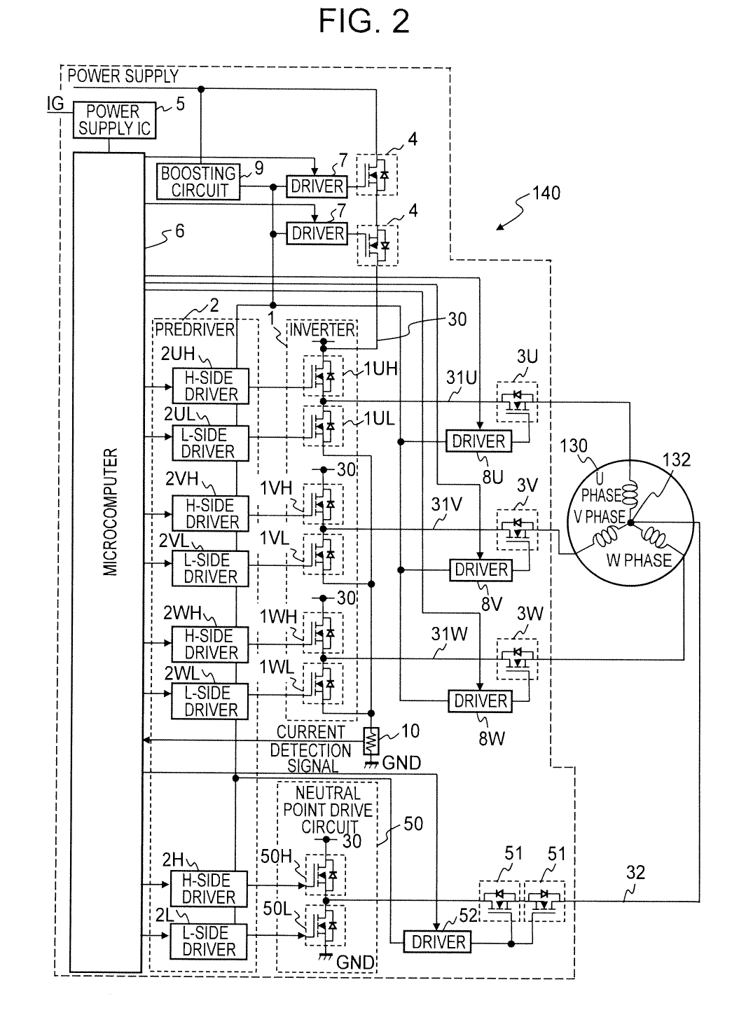

FIG. 2 illustrates a first embodiment of control apparatus 140 in electric power steering apparatus 100. Control apparatus 140 to be described below aims at controlling, as assisting motor 130, for example, a three-phase electric motor with phase coils of a U phase, a V phase and a W phase being star-connected, but can also aim at controlling an electric motor having other number of phases.

Control apparatus 140 has an inverter circuit 1 that drives assisting motor 130, a predriver circuit 2 that controls inverter circuit 1 and a neutral point drive circuit 50 to be described below, phase relays 3U, 3V and 3W, a pair of power supply relays 4, a power supply integrated circuit (power supply IC) 5, a microcomputer 6, a pair of drivers 7 that controls power supply relays 4, drivers 8U, 8V and 8W that respectively control phase relays 3U, 3V and 3W, a boosting circuit 9, and a current sensor (current sensing resistor) 10. Here, microcomputer 6 executes a control program stored in, for example, a non-volatile memory such as a flash read only memory (flash ROM) to thereby drive assisting motor 130. Parts of inverter circuit 1 and predriver circuit 2 are given as one example of a drive circuit.

Power supply IC 5 smooths a power supply voltage supplied from, for example, a power supply such as a battery and supplies an operating voltage to microcomputer 6. Boosting circuit 9 boosts the power supply voltage supplied from, for example, the power supply such as the battery to a prescribed voltage. Each driver 7 outputs a control signal of a voltage level supplied from boosting circuit 9 to power supply relay 4 according to a control signal output from microcomputer 6, to control power supply relay 4 to ON (terminal short-circuit) or OFF (terminal open). Power supply relays 4 are semiconductor relays that open and close (open and cut off) a power supply line 30 connected to a + terminal (plus terminal) of the power supply such as the battery, and each of power supply relays 4 includes, for example, an N channel metal oxide semiconductor field effect transistor (MOSFET). Specifically, in power supply relays 4, drains and sources are connected in series to power supply line 30, and gates are connected to output terminals of drivers 7. The semiconductor relays are not limited to the N channel MOSFET, and may be semiconductor switching elements such as a P channel MOSFET, an NPN transistor, a PNP transistor (the same applies to the following).

Inverter circuit 1 includes N channel MOSFET 1UH, 1UL, 1VH, 1VL, 1WH and 1WL as three sets of semiconductor elements which individually drive the respective phase coils of U phase, V phase and W phase of assisting motor 130 through drive lines 31U, 31V and 31W. In MOSFET 1UH and 1UL, drains and sources are connected in series between power supply line 30 and a ground GND, and one end of drive line 31 U is connected to a common connection point. In MOSFET 1VH and 1VL, drains and sources are connected in series between power supply line 30 and ground GND, and one end of drive line 31V is connected to a common connection point. In MOSFET 1WH and 1WL, drain and sources are connected in series between power supply line 30 and ground GND, and one end of drive line 31W is connected to a common connection point.

Furthermore, in order to diagnose abnormalities of drive systems of the phase coils of U phase, V phase and W phase in assisting motor 130, current sensor 10 that detects a drive current of assisting motor 130 is arranged between the sources of MOSFET 1UL, 1VL and 1WL, and ground GND. The current value obtained by current sensor 10 is amplified by, for example, an amplifier (not shown) or the like, and is output to microcomputer 6.

Predriver circuit 2 includes H-side drivers 2UH, 2VH and 2WH that respectively control MOSFET 1UH, 1VH and 1WH, which are upstream-side drive elements in inverter circuit 1, and L-side drivers 2UL, 2VL and 2WL that respectively control MOSFET 1UL, 1VL and 1WL, which are downstream-side drive elements. H-side drivers 2UH, 2VH and 2WH and L-side drivers 2UL, 2VL and 2WL respectively output the control signal of the voltage level supplied from boosting circuit 9 to MOSFET 1UH, 1VH, 1WH, 1UL, 1VL and 1WL according to a control signal such as a PWM signal output from microcomputer 6 to control them. H-side drivers 2UH, 2VH and 2WH have output terminals respectively connected to the gates of MOSFET 1UH, 1VH and 1WH and respectively selectively control MOSFET 1UH, 1VH and 1WH to ON or OFF. Furthermore, L-side drivers 2UL, 2VL and 2WL have output terminals respectively connected to the gates of MOSFET 1UL, 1VL and 1WL and respectively selectively control MOSFET 1UL, 1VL and 1WL to ON or OFF.

In phase relays 3U, 3V and 3W, drains and sources are connected in series between inverter circuit 1 and assisting motor 130, in short, to drive lines 31U, 31V and 31W. Each of phase relays 3U, 3V and 3W uses, for example, an N channel MOSFET as semiconductor relays, and are turned OFF when an abnormality occurred, to cut off energization between inverter circuit 1 and assisting motor 130. Gates of phase relays 3U, 3V and 3W are respectively connected to output terminals of drivers 8U, 8V and 8W. Drivers 8U, 8V and 8W output the control signal of the voltage level supplied from boosting circuit 9 to phase relays 3U, 3V and 3W according to control signals output from microcomputer 6, to control phase relays 3U, 3V and 3W to ON or OFF, thereby opening or closing drive lines 31U, 31V and 31W.

Furthermore, a neutral point 132 to which the phase coils of U phase, V phase and W phase of assisting motor 130 are star-connected is connected via a neutral point drive line 32 (electric path) to neutral point drive circuit 50 that changes the potential of neutral point 132. Neutral point drive circuit 50 includes N channel MOSFET 50H and 50L as semiconductor elements that change the potential of neutral point 132 to drive assisting motor 130. In MOSFET 50H and 50L, drains and sources are connected in series between power supply line 30 and ground GND, and one end of neutral point drive line 32 is connected to a common connection point.

Predriver circuit 2 further includes an H-side driver 2H that controls MOSFET 50H, which is an upstream-side drive element in neutral point drive circuit 50, and an L-side driver 2L that controls MOSFET 50L, which is a downstream-side drive element therein. H-side driver 2H and L-side driver 2L are controlled according to control signals such as a PWM signal output from microcomputer 6, so as to drive assisting motor 130 with the two phases free of abnormality occurrence when an abnormality has occurred in any one of the drive systems of the phase coils of the U phase, V phase and W phase in assisting motor 130. Specifically, H-side driver 2H and L-side driver 2L output the control signal of the voltage level supplied from boosting circuit 9 to MOSFET 50H and 50L according to the control signals output from microcomputer 6, to control MOSFET 50H and 50L to ON or OFF. H-side driver 2H has an output terminal connected to a gate of MOSFET 50H of neutral point drive circuit 50 and selectively controls MOSFET 50H to ON or OFF. L-side driver 2L has an output terminal connected to a gate of MOSFET 50L of neutral point drive circuit 50 and selectively controls MOSFET 50L to ON or OFF.

Cutoff relays 51 that open and close neutral point drive line 32, which includes, for example, a pair of N channel MOSFETs as semiconductor relays capable of operating at high speed, are connected in series to neutral point drive line 32. The pair of MOSFETs is connected to neutral point drive line 32 such that their drains and sources differ in direction from one another. Gates of cutoff relays 51 are connected to an output terminal of a driver 52 that controls cutoff relays 51. Driver 52 outputs the control signal of the voltage level supplied from boosting circuit 9 to cutoff relays 51 according to a control signal output from microcomputer 6, to control cutoff relays 51 to ON or OFF.

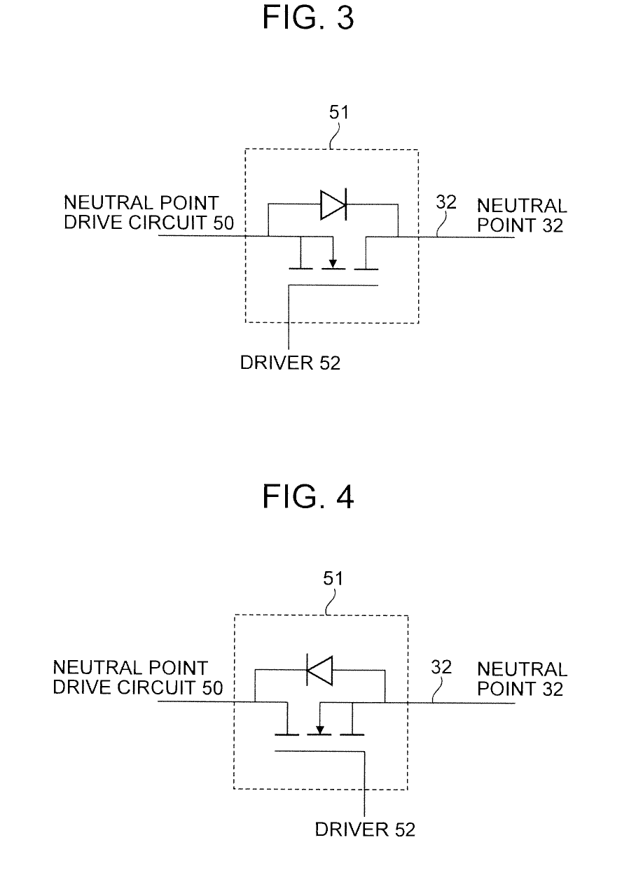

As illustrated in FIG. 3, cutoff relay 51 may be an N channel MOSFET of which the source is connected to neutral point drive circuit 50 and the drain is connected to a neutral point 32, or may be arranged such that the drain and source of the MOSFET illustrated in FIG. 3 become opposite in direction as illustrated in FIG. 4 (the same applies to the following).

Here, the operation of such a control apparatus 140 will be described. When an ignition switch is turned ON, a smoothed operating voltage is supplied from power supply IC 5 to microcomputer 6, and a power supply voltage is supplied to boosting circuit 9. Microcomputer 6 is started up, in response to the supply of the operating voltage, to execute the control program for driving assisting motor 130. Furthermore, the power supply voltage boosted to the prescribed voltage by boosting circuit 9 is supplied to H-side drivers 2UH, 2VH, 2WH and 2H and L-side drivers 2UL, 2VL, 2WL and 2L in predriver circuit 2, and drivers 7, 8U, 8V, 8W and 52.

Microcomputer 6 outputs the control signals to drivers 7, to control power supply relays 4 to ON. When power supply relays 4 are turned ON, the power supply voltage is supplied from the power supply to MOSFET 1 UH, 1UL, 1VH, 1VL, 1WH and 1WL of inverter circuit 1 and MOSFET 50H and 50L of neutral point drive circuit 50. Furthermore, microcomputer 6 outputs the control signals to drivers 8U, 8V and 8W, to control phase relays 3U, 3V and 3W to ON. When phase relays 3U, 3V and 3W are turned ON, drive lines 31 U, 31V and 31W that connect inverter circuit 1 and assisting motor 130 are opened, so that assisting motor 130 can be driven.

Then, when driving assisting motor 130, microcomputer 6 outputs control signals corresponding to steering torque signal S1 and vehicle speed signal S2, etc. to predriver circuit 2. H-side drivers 2UH, 2VH and 2WH and L-side drivers 2UL, 2VL and 2WL in predriver circuit 2 respectively output control signals to the gates of MOSFET 1UH, 1UL, 1VH, 1VL, 1WH and 1WL of inverter circuit 1 according to the control signals output from microcomputer 6, to selectively control them to ON or OFF. At this time, on the basis of steering torque signal S1 and vehicle speed signal S2, etc., microcomputer 6 dynamically changes the duty of a PWM signal, which is one example of a control signal, and controls the rotational speed of assisting motor 130. Therefore, the operation force of steering wheel 110 by the driver is transmitted to steered wheel 200 while being assisted by assisting motor 130, so that the direction of the vehicle changes.

Furthermore, microcomputer 6 diagnoses based on the current value of current sensor 10 whether abnormalities have occurred in the drive systems of the phase coils of the U phase, V phase and W phase in assisting motor 130, specifically, MOSFET 1UH, 1UL, 1VH, 1VL, 1WH and 1WL of inverter circuit 1, and the phase coils of assisting motor 130. Here, as the abnormalities of the drive systems of the phase coils, for example, opening or short-circuiting of MOSFETs, ground faults or disconnections of phase coils, etc. are diagnosed. Then, when it is diagnosed that no abnormality occurs in the drive systems of the phase coils, microcomputer 6 outputs a control signal to driver 52 in such a manner that neutral point drive line 32 is cut off by cutoff relays 51. On the other hand, when it is diagnosed that an abnormality has occurred in the drive system of one of the phase coils, microcomputer 6 outputs control signals to predriver circuit 2 such that the operation of assisting motor 130 is continued by the drive systems of the two phases free of abnormality occurrence, and outputs a control signal to driver 52 such that neutral point drive line 32 is opened by cutoff relays 51.

Thus, when no abnormality occurs in the drive systems of the phase coils in assisting motor 130, neutral point drive line 32 positioned between neutral point 132 of assisting motor 130 and neutral point drive circuit 50 is cut off. Therefore, even immediately after the abnormality has occurred in the drive systems of the phase coils, no unexpected current due to the abnormality flows in neutral point drive circuit 50, and thus, it is possible to improve the abnormality diagnostic accuracy of diagnosing the abnormality from the values of current for driving MOSFET 50H and 50L of neutral point drive circuit 50, for example.

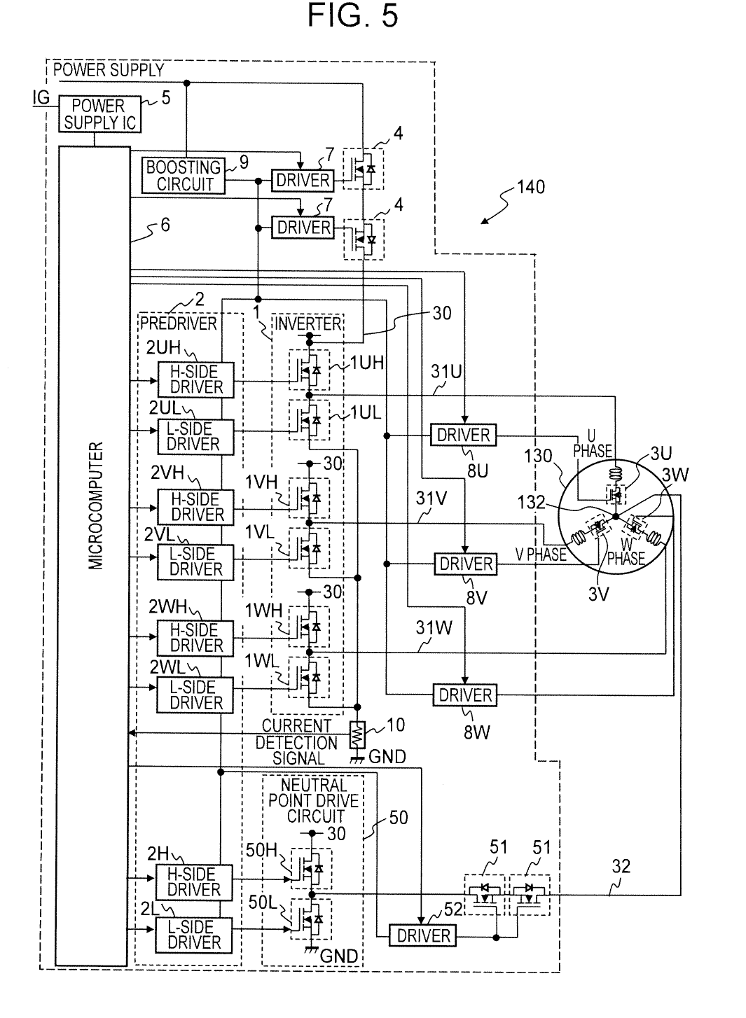

FIG. 5 illustrates a second embodiment of control apparatus 140 in electric power steering apparatus 100. In the second embodiment of control apparatus 140, only a configuration different from the previous first embodiment will be described (the same applies to the following).

In control apparatus 140 according to the second embodiment, phase relays 3U, 3V and 3W that open and close drive lines 31U, 31V and 32W have drains and sources connected in series between the phase coils of assisting motor 130 and neutral point 132. That is, phase relays 3U, 3V and 3W are incorporated in assisting motor 130. Even in this structure, drive lines 31U, 31V and 31W can be cut off by phase relays 3U, 3V and 3W, respectively. Phase relays 3U, 3V and 3W may be arranged at any position as long as they are arranged between inverter circuit 1 and neutral point 132 of assisting motor 130.

Since other operations and effects of control apparatus 140 according to the second embodiment are similar to the operations and effects of the previous first embodiment, their description will be omitted. If necessary, refer to the description of the first embodiment (the same applies to the following).

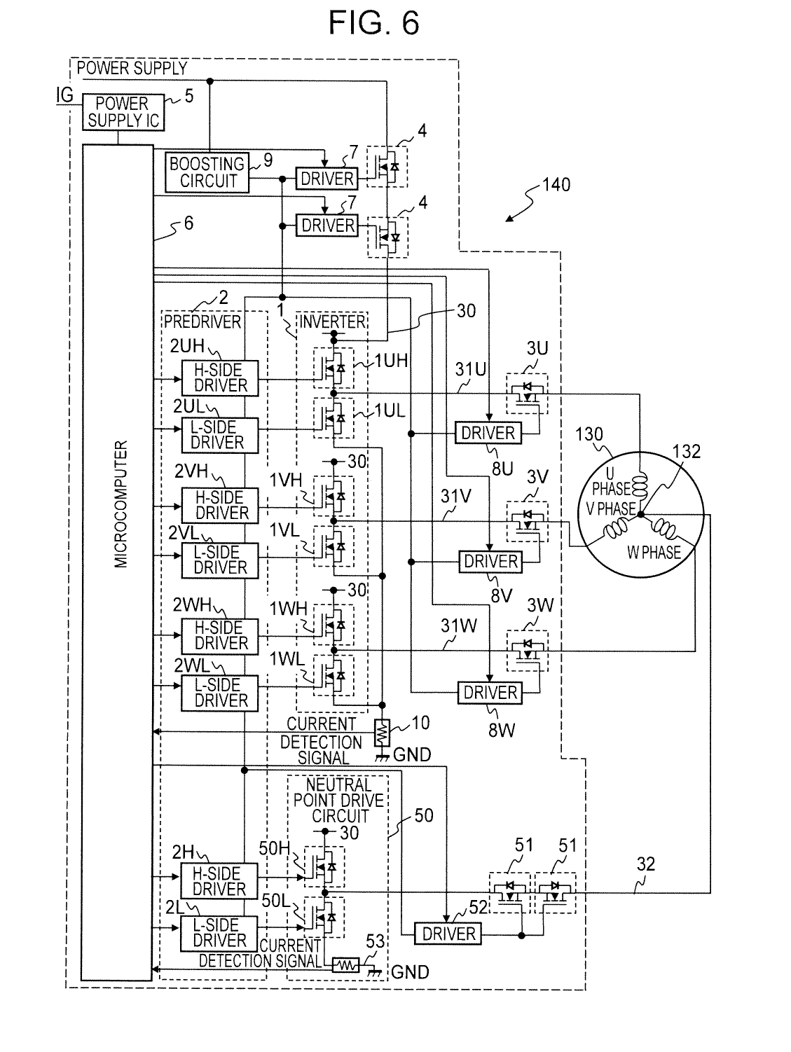

FIG. 6 illustrates a third embodiment of control apparatus 140 in electric power steering apparatus 100.

Control apparatus 140 according to the third embodiment manages a case in which abnormalities have occurred in the drive system of neutral point 132 of assisting motor 130, specifically, MOSFET 50H and 50L of neutral point drive circuit 50, and cutoff relays 51. Therefore, a current sensor 53 that detects current flowing through MOSFET 50H and 50L of neutral point drive circuit 50 is arranged between a source of MOSFET 50L of neutral point drive circuit 50 and ground GND. Furthermore, the current value obtained by current sensor 53 is amplified by, for example, an amplifier (not shown) or the like, and is output to a microcomputer 6.

When neutral point drive line 32 is cut off by cutoff relays 51, microcomputer 6 outputs a control signal for abnormality diagnosis to each of H-side driver 2H and L-side driver 2L of predriver circuit 2, for example. Furthermore, microcomputer 6 diagnoses through consistency between the current value of current sensor 53 and the control signal for abnormality diagnosis whether an abnormality occurs in the drive system of neutral point 132. When microcomputer 6 executes the abnormal diagnosis, even when microcomputer 6 outputs the control signal for abnormal diagnosis to predriver 2, the influence thereof is not exerted on the driving of assisting motor 130 because neutral point drive line 32 is cut off.

Furthermore, when microcomputer 6 has diagnosed that an abnormality has occurred in the drive system of neutral point 132, microcomputer 6 outputs a control signal to driver 52 such that neutral point drive line 32 is cut off by cutoff relays 51. When the abnormality occurs in the drive system of neutral point 132, microcomputer 6 may stop the output of the control signals to H-side driver 2H and L-side driver 2L of predriver circuit 2 and stop the control of neutral point drive circuit 50. It is thus possible to reduce power consumption.

If done in this way, since the drive system of neutral point 132 is cut off when the abnormality occurs in the drive system of neutral point 132, for example, no inappropriate voltage is applied to neutral point 132, and problems can be prevented from being caused in the driving of assisting motor 130.

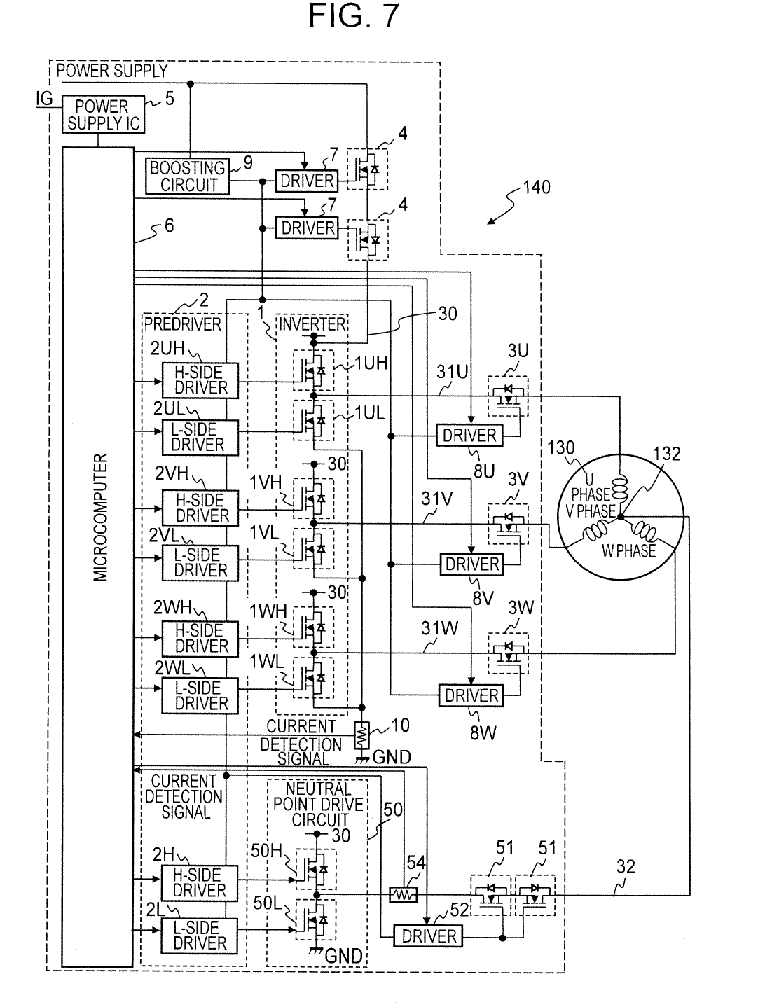

FIG. 7 illustrates a fourth embodiment of control apparatus 140 in electric power steering apparatus 100.

Control apparatus 140 according to the fourth embodiment manages an abnormality in neutral point drive line 32 of assisting motor 130, specifically, a case in which a ground fault has occurred in neutral point drive line 32 positioned between neutral point drive circuit 50 and cutoff relays 51. Therefore, a current sensor 54 that detects current flowing through neutral point drive line 32 is arranged in neutral point drive line 32 positioned between neutral point drive circuit 50 and cutoff relays 51. Furthermore, the current value obtained by current sensor 54 is amplified by, for example, an amplifier (not shown) or the like, and is output to a microcomputer 6.

When neutral point drive line 32 is cut off by cutoff relays 51, microcomputer 6 outputs a control signal for abnormality diagnosis to H-side driver 2H of predriver circuit 2 and applies a power supply voltage to neutral point drive line 32, for example. At this time, even when microcomputer 6 outputs the control signal for abnormality diagnosis to predriver 2, the influence thereof is not exerted on the driving of assisting motor 130 because neutral point drive line 32 is cut off.

Furthermore, microcomputer 6 diagnoses, based on the current value of current sensor 54, whether a ground fault occurs in neutral point drive line 32. That is, when a ground fault occurs in neutral point drive line 32 positioned between neutral point drive circuit 50 and cutoff relays 51, current flows in neutral point drive line 32 because neutral point drive line 32 is cut off by cutoff relays 51. Therefore, microcomputer 6 diagnoses, using such a phenomenon, whether the ground fault occurs in neutral point drive line 32.

When it is diagnosed that the ground fault has occurred in neutral point drive line 32, microcomputer 6 outputs a control signal to driver 52 such that neutral point drive line 32 is opened by cutoff relays 51, and outputs a control signal to L-side driver 2L of predriver circuit 2 such that MOSFET 50L of neutral point drive circuit 50 is controlled to be ON.

If done in this way, when the ground fault occurs in neutral point drive line 32, since the output of neutral point drive circuit 50 becomes a low voltage (ground voltage), a current flowing between neutral point drive circuit 50 and a ground fault point can be prevented from being excessive. Although the current can flow only from an inverter circuit 1 to assisting motor 130 in this state, If the duty of a PWM signal for driving each phase coil of assisting motor 130 is changed to control current to each phase coil, a magnetic field vector in any direction can be generated in each phase coil of assisting motor 130. It is thus possible to prevent the driving of assisting motor 130 from being influenced.

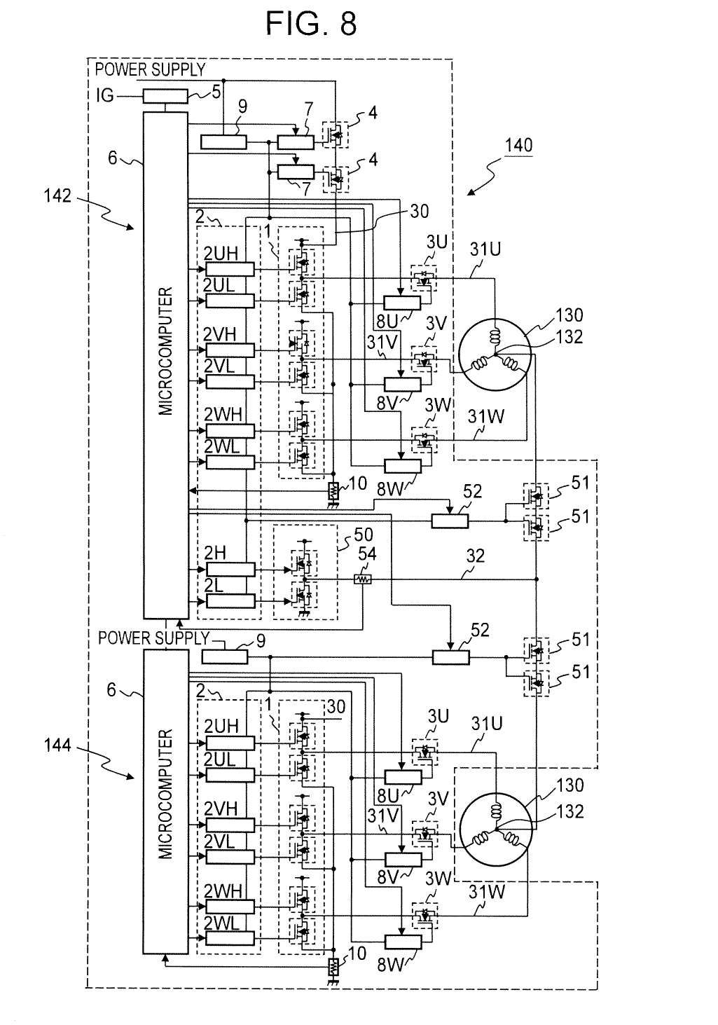

FIG. 8 illustrates a fifth embodiment of control apparatus 140 in electric power steering apparatus 100. Control apparatus 140 according to the fifth embodiment has a first control system 142 and a second control system 144 to control two assisting motors 130 different from each other.

As with the previous fourth embodiment, first control system 142 of control apparatus 140 has inverter circuit 1, predriver circuit 2, phase relays 3U, 3V and 3W, power supply relays 4, power supply IC 5, microcomputer 6, drivers 7, drivers 8U, 8V and 8W, boosting circuit 9, current sensor 10, neutral point drive circuit 50, cutoff relays 51, driver 52 and current sensor 54.

On the other hand, second control system 144 of control apparatus 140 has inverter circuit 1, a predriver circuit 2 which controls inverter circuit 1, phase relays 3U, 3V and 3W, microcomputer 6, drivers 8U, 8V and 8W, boosting circuit 9, current sensor 10, cutoff relays 51 and driver 52. In second control system 144, power supply relays 4, power supply IC 5 and drivers 7 make use of those in first control system 142. Microcomputer 6 of first control system 142 and microcomputer 6 of second control system 144 are connected via, for example, an on-board network, such as a controller area network (CAN), so as to be communicable with each other.

Drains of cutoff relays 51 of second control system 144 are connected to neutral point drive line 32 positioned between neutral point drive circuit 50 and cutoff relays 51 in first control system 142. Thus, neutral point drive circuit 50 of first control system 142 is connected to neutral point 132 of assisting motor 130 of first control system 142 and connected to neutral point 132 of assisting motor 130 of second control system 144. Therefore, first control system 142 and second control system 144 have common neutral point drive circuit 50.

In first control system 142 and second control system 144, assisting motor 130, inverter circuit 1, predriver circuit 2 and cutoff relays 51 may be made dual, and neutral point drive circuit 50 may be connected to cutoff relays 51. Also, control apparatus 140 is not limited to the configuration with such a duplexed system including first control system 142 and second control system 144, but may be a configuration with a multiplex system including three or more control systems. Furthermore, a plurality of electric motors that are objects to be controlled by control apparatus 140 are not limited to assisting motor 130 of electric power steering apparatus 100, but may be electric motors of different systems, for example, an electric motor of a brake system, an electric motor for a seat belt apparatus, an electric motor of an electric parking brake system, etc.

Thus, neutral point drive circuit 50 used only when an abnormality occurs in the drive systems of the phase coils of assisting motor 130 can be shared as a common component, resulting in the reduction in size and cost of second control system 144.

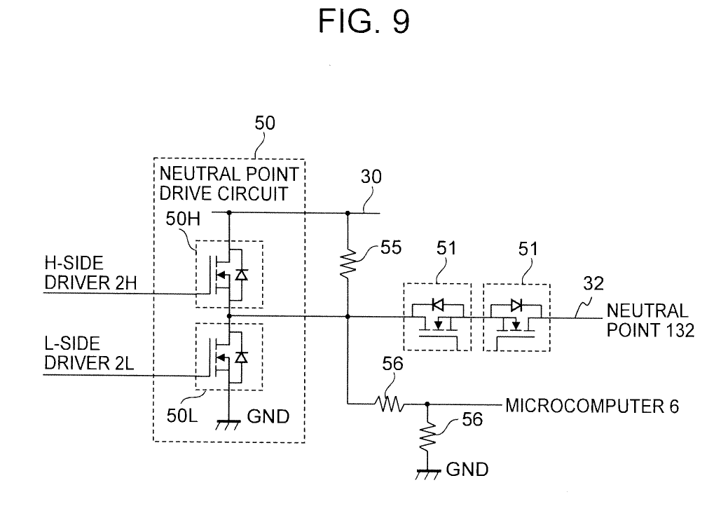

Here, in the fourth embodiment and the fifth embodiment, illustrated in FIG. 7 and FIG. 8, a pull-up resistor 55 and two pull-down resistors 56 may be used instead of current sensor 54, as illustrated in FIG. 9 to diagnose whether a ground fault occurs in neutral point drive line 32. Specifically, pull-up resistor 55 is arranged between power supply line 30 and neutral point drive line 32 positioned between neutral point drive circuit 50 and cutoff relays 51. Furthermore, ground GND is connected via two pull-down resistors 56 to a connection point of pull-up resistor 55 in neutral point drive line 32. Then, microcomputer 6 diagnoses whether a ground fault occurs in neutral point drive line 32, from the potential of a common connection point of two pull-down resistors 56 in a state in which MOSFET 50H and 50L of neutral point drive circuit 50 have been controlled to be OFF.

Control apparatus 140 of the electric motor described above can be applied not only to electric power steering apparatus 100, but also to, for example, an electric oil pump or the like using a multiphase electric motor with a plurality of phase coils star-connected. Furthermore, as for control apparatus 140 of the electric motor, the technical features of the first to fifth embodiments can also be replaced appropriately or combined appropriately. Furthermore, ground GND can also be taken to be a “-potential” (negative potential).

### REFERENCE SYMBOL LIST

1 inverter circuit
2 predriver circuit
6 microcomputer
10 current sensor
32 neutral point drive line (electric path)
50 neutral point drive circuit
51 cutoff relay (semiconductor relay)
53 current sensor
54 current sensor
55 pull-up resistor
56 pull-down resistor
130 assisting motor (electric motor)
132 neutral point

1. A control apparatus for an electric motor, comprising:
a drive circuit that drives the electric motor in which a plurality of phase coils are star-connected;
a neutral point drive circuit connected to a neutral point of the star connection;
semiconductor relays that cut off an electric path connecting the neutral point and the neutral point drive circuit; and
a microcomputer that cuts off the electric path by the semiconductor relays when the electric motor can be normally driven by the drive circuit.

2. The control apparatus for the electric motor according to claim 1, wherein the microcomputer is configured to diagnose whether or not an abnormality has occurred in the neutral point drive circuit or the electric path, when the electric path is cut off by the semiconductor relays.

3. The control apparatus for the electric motor according to claim 2, wherein the microcomputer is configured to cut off the electric path by the semiconductor relays when the microcomputer diagnoses that the abnormality has occurred in the neutral point drive circuit.

4. The control apparatus for the electric motor according to claim 2, wherein when the microcomputer diagnoses that the abnormality has occurred in the electric path, the microcomputer is configured to stop the cutoff of the electric path by the semiconductor relays and switch an output of the neutral point drive circuit to a low voltage.

5. The control apparatus for the electric motor according to claim 1, wherein the electric motor, the drive circuit and the semiconductor relays are made multiplex, and the neutral point drive circuit is connected to each of the semiconductor relays.

6. The control apparatus for the electric motor according to claim 1, wherein the microcomputer is configured to diagnose based on a drive current of the electric motor whether the electric motor can be normally driven or not.

7. The control apparatus for the electric motor according to claim 2, wherein the microcomputer is configured to diagnose based on the value of a current flowing through the neutral point drive circuit whether the abnormality has occurred in the neutral point drive circuit or not.

8. The control apparatus for the electric motor according to claim 2, wherein the microcomputer is configured to diagnose based on the value of a current flowing through the electric path whether the abnormality has occurred in the electric path or not.

9. The control apparatus for the electric motor according to claim 1, wherein when it is not possible to normally drive the electric motor by the drive circuit, the microcomputer is configured to drive the electric motor by a part of the drive circuit and the neutral point drive circuit.

10. A control method for an electric motor in which a plurality of phase coils are star-connected, comprising the step of allowing a microcomputer to cut off an electric path positioned between a neutral point of the star connection and a neutral point drive circuit connected to the neutral point by semiconductor relays arranged in the electric path when it is possible to normally drive the electric motor by a drive circuit.

11. The control method for the electric motor according to claim 10, wherein the microcomputer diagnoses whether or not an abnormality has occurred in the neutral point drive circuit or the electric path, when the electric path is cut off by the semiconductor relays.

12. The control method for the electric motor according to claim 11, wherein the microcomputer cuts off the electric path by the semiconductor relays when the microcomputer diagnoses that the abnormality has occurred in the neutral point drive circuit.

13. The control method for the electric motor according to claim 11, wherein when the microcomputer diagnoses that the abnormality has occurred in the electric path, the microcomputer stops the cutoff of the electric path by the semiconductor relays and switches an output of the neutral point drive circuit to a low voltage.

14. The control method for the electric motor according to claim 10, wherein the microcomputer diagnoses based on a drive current of the electric motor whether the electric motor can be normally driven or not.

15. The control method for the electric motor according to claim 10, wherein when it is not possible to normally drive the electric motor by the drive circuit, the microcomputer drives the electric motor by a part of the drive circuit and the neutral point drive circuit.
